(19) United States
(12) Patent Application Publication
(10) Pub. No.: US 2012/0256860 A1
(43) Pub. Date: Oct. 11, 2012

(54) Directional Finger Recognition Authoring

(76) Inventor: James Robert Justice, San Francisco, CA (US)

(21) Appl. No.: 13/440,989

(22) Filed: Apr. 5, 2012

Related U.S. Application Data
(60) Provisional application No. 61/471,976, filed on Apr. 5, 2011.

(51) Int. Cl. G06F 3/041

(52) U.S. Cl. 345/173

(57) ABSTRACT

A directional finger recognition authoring system and method provides an alphanumeric input system using a touchpad interface.

### RELATED APPLICATIONS/PRIORITY CLAIM

This application claims priority under 35 USC 119(e) and 35 USC 120 from U.S. provisional patent application Ser. No. 61/471,976 filed on Apr. 5, 2011 and entitled “Directional Finger Recognition Authoring” which is incorporated herein by reference.

### FIELD OF THE INVENTION

The invention is related to a system and method for inputting data into a computing device and in particular a touchpad based system for translating finger movements to written language.

### BACKGROUND OF THE INVENTION

There are conventional methods for inputting written language into a computing device. The best known and most widely used method is currently the computer keyboard. The computer keyboard evolved directly from the keypad arrangement developed for the mechanical typewriter, “Remington No. 2,” which is noted for introducing the fully functional QUERTY keyboard in 1874. Though originally developed for a finger to generate physical force which the typewriting machine translates into the mechanical striking of a character specific typebar against an ink ribbon onto a piece of paper, the common arrangement and structure of the typewriter keyboard provided the basic design for the electric typewriter and ultimately the computer keyboard. The same layout has also been repurposed for inputting characters on touchpads and touchscreens whereby the images of the keyboard keys are projected on a touchscreen and the user inputs a character by touching the key-image on the touchscreen indicating the character being inputted by the user.

Other, less widely used methods include various schemes for inputting characters using a stylus whereby the user draws a specific pattern on the touchscreen for each character using the stylus. Another method uses computer processing to interpret the most likely word or phrase the user intends to input, even when the user's technique is sloppy. Another method uses computer processing to interpret the sliding gesture of a user's fingers to indicate which key-image the user intends to input.

These state-of-the-art methods for input generally require that the touchpad device either display key-images in specific locations on the touch surface or that the touch surface be oriented so that the device can recognize the relational direction of the movement of a stylus or finger in the two dimensional space.

Thus, it is desirable to provide a directional finger recognition system and method that overcomes the limitations of conventional systems and allows a user to use a single hand, laid indiscriminate of orientation on a touchpad surface, without the use of a stylus.

### SUMMARY OF THE INVENTION

A directional finger recognition authoring system and method (“DFR”) are provided. The system provides software which resides on a computing device connected to a touchpad device. The touchpad device recognizes the location and movement of a finger or multiple human fingers at once or other body part which is touching the touchpad surface and translates these movements into written language which can be recorded or communicated by the computing device.

The system in accordance with the invention solves the limitations of conventional systems by enabling a skilled user to enter written language into a device with one hand at an accelerated rate without the need to actually view the device. The touchpad can be a conventional two dimensional touchpad, partially rounded for a more comfortable experience or even embedded in clothing whereby a skilled user could enter written language into a computing device by touching the clothing, for example, by touching and embedded touchpad on the top of the thigh.

The system may offer several modes of operation by which a user can enter a character or word on the device including a Standard Mode and a Signature Mode, whereby the Signature Mode utilizes a user's specific complex finger signature profile (“CFSP”) to recognize finger movements specific to the individual user when recognizing the intended written input.

The system offers several modes of finger recognition by which the system identifies which finger of the hand is touching the pad, the location and orientation of the finger on the pad.

A directional finger recognition authoring apparatus is provided. The directional finger recognition authoring apparatus comprises a touchpad input device, a computing device, software, and an optional network connection for connecting the computing device to an optional remote computer or “server.” The server contains a database with user specific CFSPs which can be accessed from anywhere.

The following invention allows an alternative to the traditional computer keyboard. It provides a technology by which an individual can utilize a touch screen or touch pad with one hand to enter alpha-numeric characters and writing symbols (“characters”) into that computing device.

The system offers significant advantages to current entry methods. The technology is designed for use by one hand. A user can touch any part of the Touchpad and is not restricted to areas of the Touchpad designated for certain Characters as with conventional touchpad input technologies. The technology allows for a skilled individual to enter data at a high rate of speed. The input “pad” does not need to be flat, but could be curved or even supple. The technology could be conveniently worn as an accessory on or combined with clothing. For instance, a user might wear an input device on a sleeve or leg. The technology works well in situations where voice recognition is inappropriate, such as environments where the user must be quiet. The user does not need to see the “pad” or a monitor when inputting characters. The system could be used in the dark.

Within the description of the system and apparatus, “touch pad,” “touch screen,” and “pad” will be used interchangeably to represent a device which can be used to identify the touch and directional movement of a human finger as described herein.

### BRIEF DESCRIPTION OF THE DRAWINGS

FIG. 1 is diagram illustrating the parts of a hand touching the surface when naturally resting on a touchpad.

FIG. 2 is a diagram of a processed map of the finger positions of a hand touching the surface when naturally resting on a touchpad.

FIG. 3 is a diagram of processed map of the finger positions displaying the recognized end fingers and measurements processed to determine thumb and pinky.

FIG. 4 is a diagram of a processed map of the finger positions showing the recognized fingers of the hand.

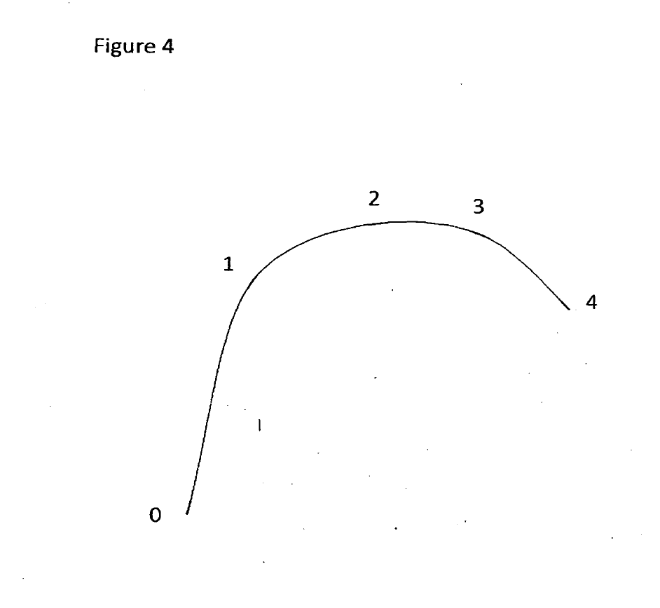

FIG. 5 is a diagram of a processed map of the finger positions showing the orientation line against which movements of the fingers will be measure for direction.

FIG. 6 is a diagram demonstrating the contact maps of various fingers on a touchpad surface.

FIG. 7 is a diagram of a processed map of the finger positions showing the recognized and processed movement of the middle finger along with incidental negative data which is processed and ignored.

FIG. 8 is an architectural diagram of touchpad device connected to a remote server via a network and illustrates a method for accessing a remote CFSP.

### DETAILED DESCRIPTION OF THE EMBODIMENT

A directional finger recognition authoring system and method (“DFR”) are provided comprising DFR software which resides on a computing device connected to a touchpad device. The touchpad device recognizes the location and movement of human fingers or other body parts touching its surface and using conventional software or firmware processes various aspects the point(s) of contact including the location of the point of contact, the area of contact and the direction of any movement of the point of contact.

The invention detects a minimum of three factors concerning the movement of a user's fingers on a surface, the combination of which will allow for any individual to “digitally type” alphanumeric characters or shortcut words into a computer device. The input information can be used in the same way as alphanumeric information currently typically inputted using standard Qwerty keyboard, a shorthand keyboard (stenotype keyboard) or other conventional input device.

The invention uses three factors to determine an alphanumeric character (“Character”) being entered by a hand on a touchpad including the finger of the hand that is touching the pad i.e. ‘right hand pointing finger,’ right hand ring finger,’ etc.); the direction of the movement of a finger on the pad relative to the position of the hand, rather than any specific orientation of the pad in space; and the combination of two or more fingers on a keypad and the combined directional movement of those fingers on the Keypad. For instance, a thumb and a pointing finger making a squeezing motion.

It is the unique combination of the finger(s) in motion across the surface of a Touchpad and the direction of any swiping motion of those fingers which will be used to identify the Character being entered into the Computer.

In this documentation of the invention, the Thumb of the hand might also be referred to as a Finger, though this may not be considered anatomically correct.

The invention provides for a solution for inputting written language using the entire hand at once called “Multipoint” input or for inputting written language using only the fingers which are relevant to the character or word being inputted at a given time, called “Target Point” input.

The invention relates strongly to the software that receives input from a touchpad and the decisioning and processes which are described herein describe the work that is operated by the computing device as determined by the software. Thus, the software provides the instructions for how to interpret the data from the touchpad and for how the computer device should process that data so as to interpret the written language.

Multipoint allows the user the user to rest an entire hand on the device which is useful for larger touchpads that can accommodate the size of an entire hand. Multipoint requires that the system recognize the hand orientation and to recognize negative data as is described herein.

Target Point input is useful for smaller touchpad screens, such as that combined with a mobile phone, whereby the user only has room on the touchpad for the fingers relevant to the character or word being inputted a given moment. Touchpoint requires that the system recognize individual fingers and their orientation either by the finger map or by a combination of finger map and fingerprint.

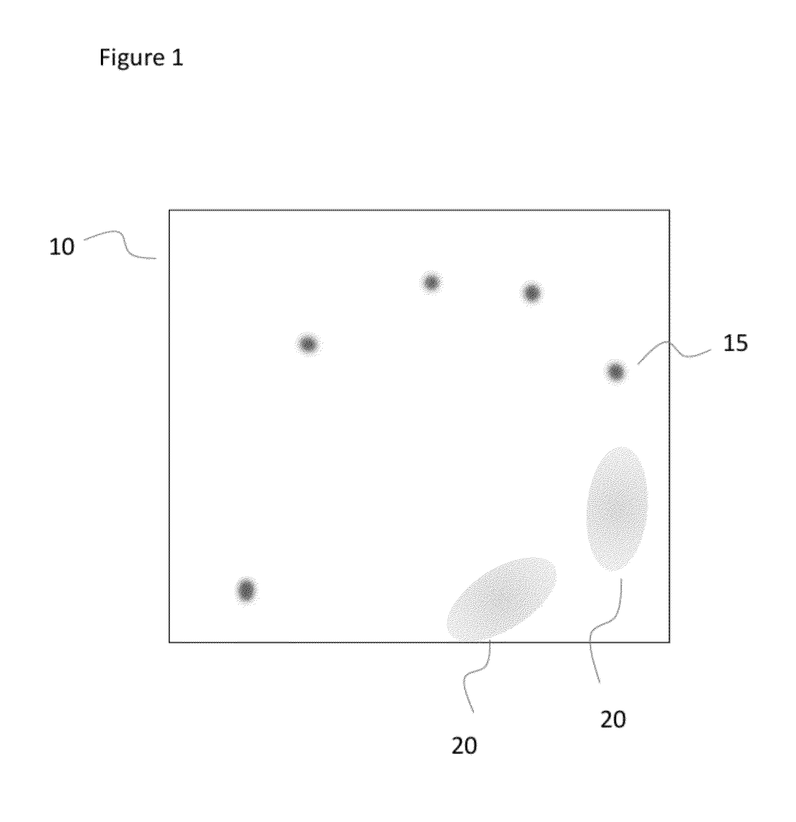

In a Multipoint system, the user places a hand on the touchpad surface. This may or may not include resting the palm on the surface. FIG. 1 illustrates the boundaries of a touchpad screen 10 and the touch points of a resting hand on that surface, including the lower palm 20 and five finger touches or “finger points” 15. This information is used to produce a “touch map.” The touch map is collected by the touchpad, then processed by the computing device to remove “negative information” or information that is not relevant to the intended input by the user.

This negative information includes a palm print. The palm print 20 tends to be significantly larger than the relevant finger points on the screen and can be filtered as negative data for this characteristic.

Observing the layout of the touch points of the fingers resting on a surface, it becomes obvious that nearly all normally developed human hands will follow a natural wave or arc-like pattern where the distance from the finger point of the thumb (“thumb”) to the finger point of the pointing finger (“pointing finger”) is the furthest distance between consecutive points.

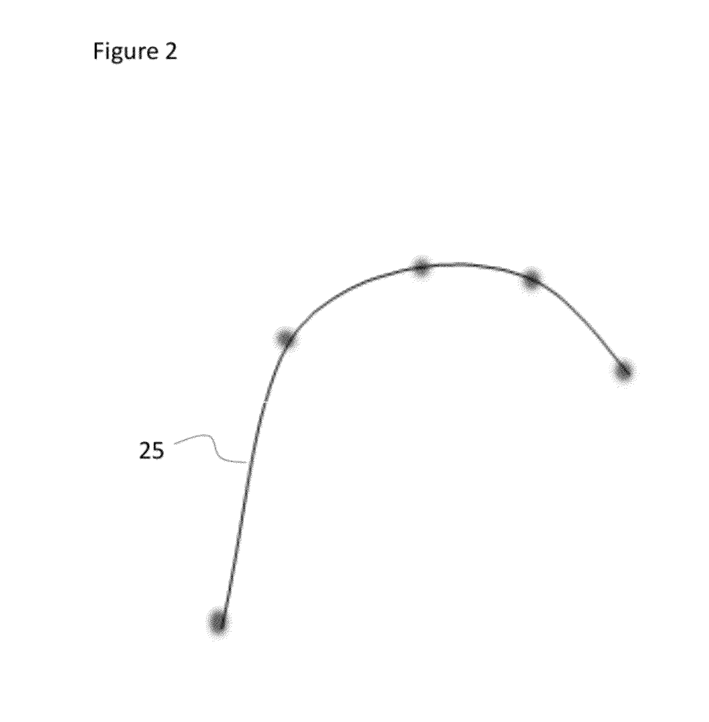

As illustrated in FIG. 2, the computing device then establishes a finger pattern line 25 which is calculated by connecting each finger point to the next nearest finger point establishing a continuing line.

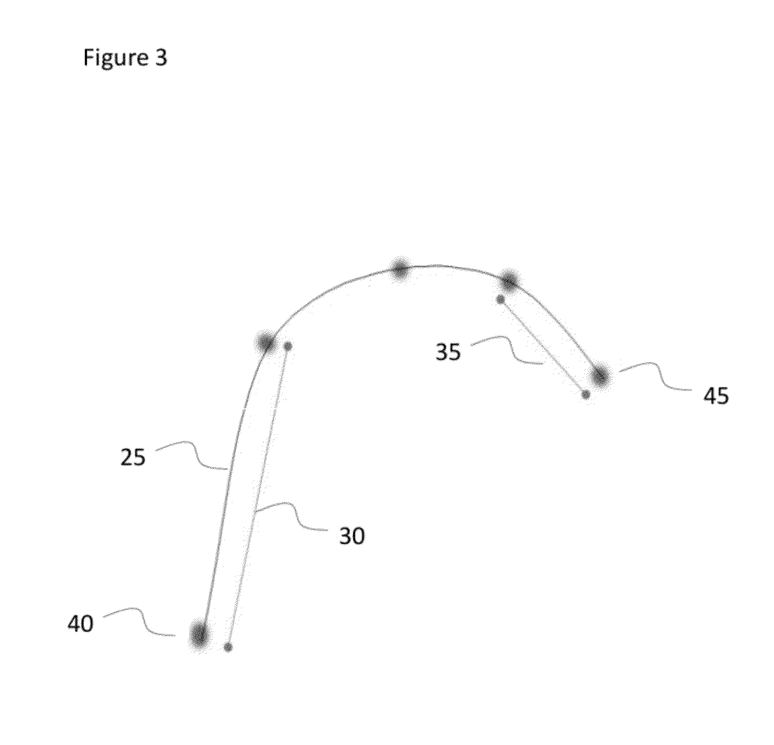

FIG. 3 illustrates a method by which the software distinguishes the thumb from the pinky. When a hand rests naturally on a surface, the thumb tends to fall further from the index finger than the pinky does from the ring finger. By taking the end finger points on the finger pattern line 25 and measuring the distance to the nearest finger point from each of those two end finger points, it can be assumed that the end finger point with the greatest distance 30 to its neighbor is the thumb 40 and the other endpoint is the pinky 45. This determination is critical to the function of the system. Should this technique not work correctly and the resulting input from the user erroneous, a backup procedure provides that the software request the user determine, by inputting a selection, which hand (right or left) is being used. In this case the thumb and pinky can easily be determined.

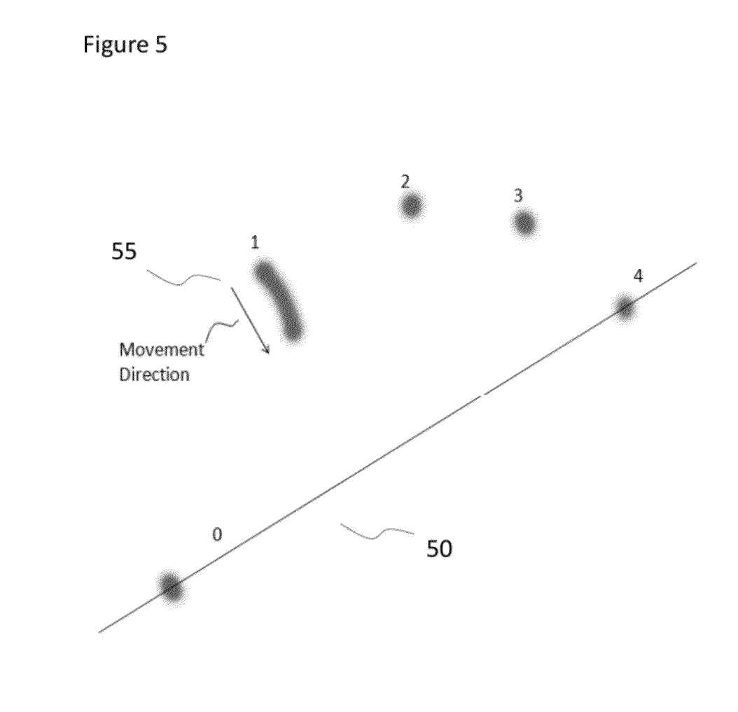

Once the software has identified the thumb and pinky, the other finger points can be associated with the other fingers of the hand as shown in FIG. 5 whereby the following are identified, thumb 0, pointing finger 1, middle finger 2, ring finger 3 and pinky 4.

In order to determine the relative motion of a finger relative to the hand, the software either determines which two finger points are furthest apart, or uses the already gather data to identify the thumb and pinky, then draws straight line 50 between the two as shown in FIG. 5. This line 50 is the orientation line or “O-line” and provides a reference plane, or orientation against which the directional finger movements can be calculated.

Thus, the described apparatus, as programmed to follow above logic, can determine which hand rests on a touchpad device, the identity of each finger and the directional movement of any finger as demonstrated with the pointing finger 55 relative to the position of the hand. This information can be used by the software to record finger movements associated with letters, numbers, symbols or whole words and record or communicate this input as intended by the user.

The same can be accomplished using a target point method. To utilize the target point method of finger recognition, a user must prerecord fingerprints/finger touches. To do so, the software would message to the user using any of various methods, “Please place your thumb on the pad.” The user would do so, allowing the device to capture the information and pass it to the computing device where it would be stored under a user profile as a “finger signature” or “FS.” Collectively, the finger signatures for one hand of an individual user form the finger signature profile or “FSP.” (Note special services devices can be configured for users who may have less than five fingers).

The resting position of the thumb on a flat surface may result in a contact map but no fingerprint information since the thumb typically lies to the side. For this reason, in a sequence of entries for certain fingers, it may on be necessary to use only the contact map to identify the thumb, even if the touchpad device is capable of reading fingerprints.

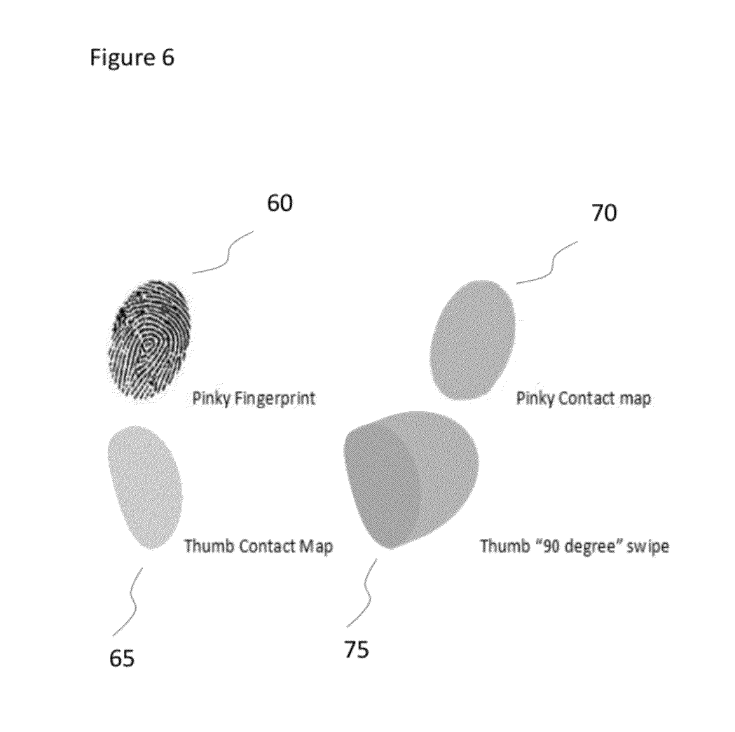

Subsequent finger touches by the same individual can then be identified. FIG. 6 illustrates three static, non-moving, examples of finger points on a touchpad (60, 65 70) and one moving finger called a swipe 75 example. When a touchpad is touched with a finger, each finger leaves a unique pattern as can be determined by two variants. The first is the fingerprint 60—every finger has a unique finger print; and the second is the contact map—every finger leaves a distinctive outline, forming a unique imprint shape. Note the contact map for the thumb 65 and pinky 70 are entirely different, constitute different sizes and shapes. The computing device uses a pattern recognition software component to recognized the distinctive differences in geometries and to identify each finger against the stored information accordingly Target point then establishes the direction of the swipe of the finger. Not all touchpads have the resolution ability to capture a fingerprint. These devices would rely entirely on the contact map to identify the finger.

“Negative data” is input data captured by the pad and subsequent computer that is incidental to the intended input data by the user. Negative Data is most relevant with Multipoint Input where non-active fingers and parts of the hand are resting on the pad surface while other fingers are inputting data. For example, a user may rest his hand and fingers on the pad or part of his hand on the pad while using fingers to input data. Or, a user might rest all of the fingers on the pad and when attempting to input a character with a middle finger, might also slightly move the pointing finger.

### Character Entry Signature (CES)

The CES is the specific “code” used to enter a character on the pad. For example the touch of a ring finger moving at 180 degrees (a “180 degree swipe”) (relative to the O-line might represent the letter “k”. The same finger with a 0 degree swipe might represent the letter “i”. A 90 degree swipe of the thumb might indicate the following letter is capitalized.

Two fingers moving together can also represent characters or even entire words. For example, the pinching motions of the forefinger and the index finger might indicate the work “and.”

Thus a character entry signature is the unique “combination” of finger-signature(s)+swipe direction of the identified finger(s) of the hand. This combination results in a code that references an input character or word.

### CES Set

A “CES Set” is a group of CES's necessary to represent a set of alpha-numeric characters necessary to write or author written language. For example, a CES Set would represent the character set found on currently computer keyboard.

For the sake of the continued description of this invention, it will be assumed that all of the fingers discussed are on the same hand, though a CES Set could also be derived to use both hands (where by the left pointing finger and right pointing fingers create different characters with the same directional swipe.)

While this document includes a recommended CES set and basic character set for the English language, the invention can allow for customization of the Character Set on a particular device. This customization could be performed by an individual or in mass production to accommodate different languages or a manufacturer's personal preference. Thus a device could be programmed such that a 180 degree swipe of the pointing finger could input different characters on different devices.

Though the CES is programmable or determinable by the manufacturer, programmer or user of the device, in order to define a workable description of the invention, a recommended, but limited, CES set is included. This will be called the Simple Standard CES Set. In order to define a CES, a combination of three symbols will be used to represent the finger, finger direction or motion, and finger action.

1=pointing finger
2=middle finger
3=ring finger
4=pinky
5=thumb
U=swipe motion of 0 degrees or “Up”
R=swipe motion of 90 degrees or “Right”
D=swipe motion of 180 degrees or “Down”
L=swipe motion of 270 degrees or “Left”
T=Tap of a finger or multiple fingers—no swiping motion.
P=swiping fingers together or toward each other—in a pinching motion.
A=swiping fingers apart or away from each other

For example a pointing finger swiped upward relative to the hand would be represented here by the code “1U”. A ring finger swiped to the right would be represented as “3R.” A thumb and pointing finger swiped together in a pinching motion would be “15P.”

While not shown a two handed entry system could designate a right or left hand with the addition of an L or R at the beginning of the code such as “R1R”—right hand pointing finger swiping right.

### Standard CES Set

The following suggests a standard CES set for basic characters. All standard English keyboard characters are not represented here and can be later determined when building the invention.

### 1U=“A”

### 1R=“B”

### 1D=“C”

### 1L=“D”

### 2U=“E”

### 2R=“F”

### 2D=“G”

### 2L=“H”

### 3U=“I”

### 3R=“J”

### 3D=“K”

### 3L=“L”

### 4U=“M”

### 4R=“N”

### 4D=“O”

### 4L=“P”

### 5U=“Q”

### 5R=“R”

### 5D=“S”

### 5L=“T”

### 12U=“U”

### 12R=“V”

### 12D=“W”

### 12L=“X”

### 23U=“Y”

### 23R=“Z”

### 1T=“1”

### 2T=“2”

### 3T=″3″

### 4T=“4”

### 5T=“5”

### 51T=“6”

### 52T=“7”

### 53T=“8”

### 54T=“9”

### 512T=“0”

### 12R=“Space”

### 51P=“Shift”

### 52P=“Return”

12D=“Quotation marks”

### 123T=“Period”

### 123L=“Comma”

### 1234L=“Backspace”

### Sequences

The following characters will use a string of two motions to enter a character. A string is entered with the same finger making two motions while not leaving the surface. For example, a

1DR motion would be the pointing finger swiping down and to the right, forming an “L” shape.
1DR=“Plus sign”
1DL=“Minus sign”
12DR=“Equal sign”

### Drawing Characters

Certain symbols and characters can be entered by using a direct drawing mode whereby the user simply draws the symbol using the pointing finger. This method could be used for characters such as parentheses, brackets, exclamation points (whereby the system recognizes a “C” with a dot below and then expos facto interprets the entire entry as an exclamation mark—as was intended by the user.)

For the Standard CES set, Characters which will use the Drawing method are:

˜
!
@
̂

### &

(
)
\
?

### Negative Data

A computer algorithm, as part of the DFR software architecture, recognizes unintended incidental motions and ‘logically filters’ this information when running pattern recognition processes which capture the intended input.

DFR provides for logically filtering this negative data. An algorithm stores all of the finger motions in association with the intended input such that the cumulative data representing the total motion of the hand and fingers for an ‘intended’ input motion actually becomes the representative CES for that particular individual's input of an intended character. This customized CES for an individual will be called the Complex Finger Signature or (CFS).

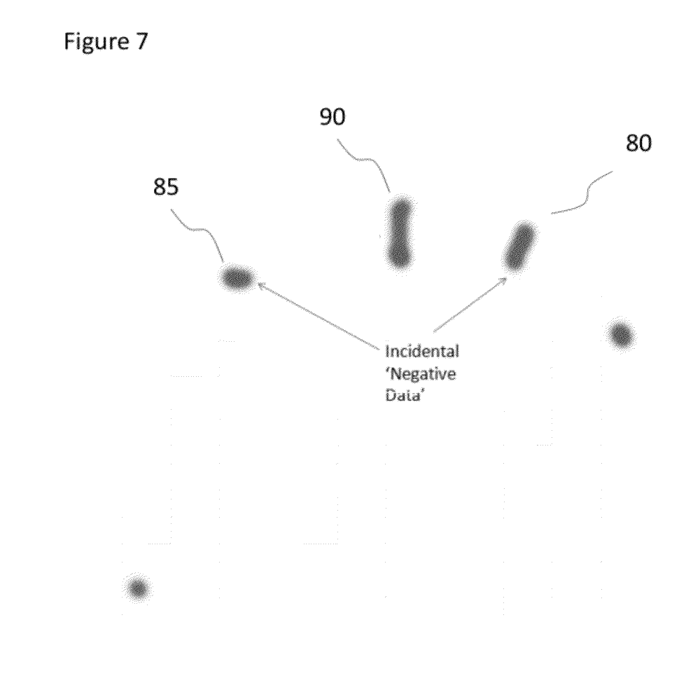

FIG. 7 illustrates negative data shown as the unintended finger movements of the ring finger 80 and pointing finger 85 along with the intended swipe of the middle finger 90. This is very natural as most people tend to move adjacent fingers when moving an intended finger. Also note that the intended motion is not actually 90 degrees to the O-line. This data combines to form the negative data. By establishing a CFS for this individual, these nuances are recorded so that the pattern recognition algorithm properly recognizes that this user is intending to input a “g.”

Negative data can be used using a software algorithm designed to recognize common human motions or the system can identify negative data using one of the learning methods below in the section title Learning and the CFS Profile (CFSP).

The system can handle negative data a couple of ways: The computing device can filter negative data prior to performing a match against the database. This would typically be done using a computer algorithm and would best be applicable for use with a publicly available DFR system; or, in the case that a CFSP has been created, the database can store negative data commonly created by a user such that the negative data is actually part of the Finger-Signature. This would be typically be most useful for a personal DFR system, where the user has setup a CFSP.

### Resting Fingers Recognition (RFR)

“Resting” is a type of negative data that can be identified using a software algorithm. The intent is to determine resting fingers (or parts of the hand) that may be touching the pad inadvertently, but that the user does not intend to be using for character entry. Like other negative data, data from “Resting fingers” will be filtered out when determining the intended finger motion of the user.

In such a case, the software can detect that a resting finger becomes active if the finger either moves in a deliberate motion or is lifted from the pad surface and returned to the surface—for example if a user wants to tap (T) the surface from a resting finger, the finger is lifted then used to tap the surface—a tap is a quick jab motion with little horizontal motion where the finger tip briefly touches the surface.

By the system successfully ignoring resting fingers, a user can rest his entire palm and hand on the pad without effectuating character entry. When the user decides to enter a character, he simply moves the appropriate combination of fingers in a deliberate manor which signals the software that an entry is being made.

Utilizing DFR with Negative Data Recognition and RFR, a skilled user entering data on the data pad may look as if she is actually massaging the words directly into the pad.

### Learning and the CFS Profile (CFSP)

A DFR can learn an individual user's specific nuances when entering written language—Active and/or Passive.

CFSs are a type of Finger-Signature which stores more information than a basic CFS. For example, a CFS can be a Finger-signature combined with the movement of that finger that is together stored to represent a specific character that the user intends to input. The difference between storing a Finger-Signature and a CFS is that the stored CFS can account for an individual's individual nuances in the way he swipes his finger (includes negative data). Using CFS information in pattern recognition for user input should prove to be a more accurate method of using DFR. “Profile” refers to either the CFSP or FSP of the user.

Using the active method, a user “trains” the DFR device to learn CFS information. A CFSP is created by the user performing DFR input for each character and/or strings of characters

in response to the software requesting the user to perform a certain swipe (for example, a 1U), the pad captures data both about the Finger-Signature and negative data which is easily identified since the intended swipe motion is already known, then stores this combined information as a data point in the CFSP record in the database. The user might spend a few minutes answering requests by the software to make certain motions on the pad with certain fingers or to simply input every character/word shortcut available to establish a personal signature for each motion. Each time the captured information is stored, the computer effectively “learns” about the user.

Other aspects of the swipe motion that might be captured by an advanced DFR apparatus which could include accuracy include the speed of the swipe and the change of the contact map between the beginning and end of the swipe.

According to a passive method, a CFSP can be established and continuously improved. Using the passive method, the apparatus learns a user's CFSP as the user enters data over time. This learning will increase the accuracy of the apparatus and the speed at which the user can enter characters over the time the user uses the DFS device.

One suggested method is “correction analysis.” With correction analysis, each time the user makes a character entry; information about the CFS is stored temporarily in memory and associated with the character the device matched (using the best effort of software matching the input swipe to the CFSP stored in the database). This temporarily stored CFS information will called an “eph.”

The apparatus can us ephs to continually learn the specific nuances of an individual user's input techniques. During a user input, the information stored on an ephemeral basis in short term memory which includes the data collected to be used in matching the input from the user to Finger-Signature or CFSs in the database. Ephs contain pertinent data which is extracted from the raw data. For example, raw data may contain a graphical image of the finger print while the pertinent data stored in the eph might information extracted from that raw data, such as the distance between the first and second ridges of a finger print, the height and width of the finger map etc. There is a significant amount of technology in the marketplace necessary to identity and match fingers using fingerprints and other biometric characteristics of fingers. This technology provides component to the invention described herein but is not solely unique. The eph also contains the swipe information about the input including direction and type of the swipe.

If a mistake in the match is made and user performs an expected patterned response when the mistake is recognized (by the user), the user will usually perform one of several correction patterns, for example, the user hits the back space and then carefully changes the character by re-inputting. The software will recognize the correction pattern, then pulls the relevant eph from memory and stores characteristics of the eph in the FSP under in data fields called negative signature data.

Accordingly, in one embodiment of the invention the software program constantly accumulates ephs for characters that were successfully entered, and stores the information from these ephs in the FSP under data fields called positive signature data.

Both positive and negative signature data can be used in the matching of FSPs to inputting ephs.

In one embodiment of the invention, CFSPs are stored locally by the computing device in local storage such as on a hard drive included with the device. In second embodiment of the invention, CFSPs are stored remotely on a server and accessed via a computer network or public computer network such as the internet.

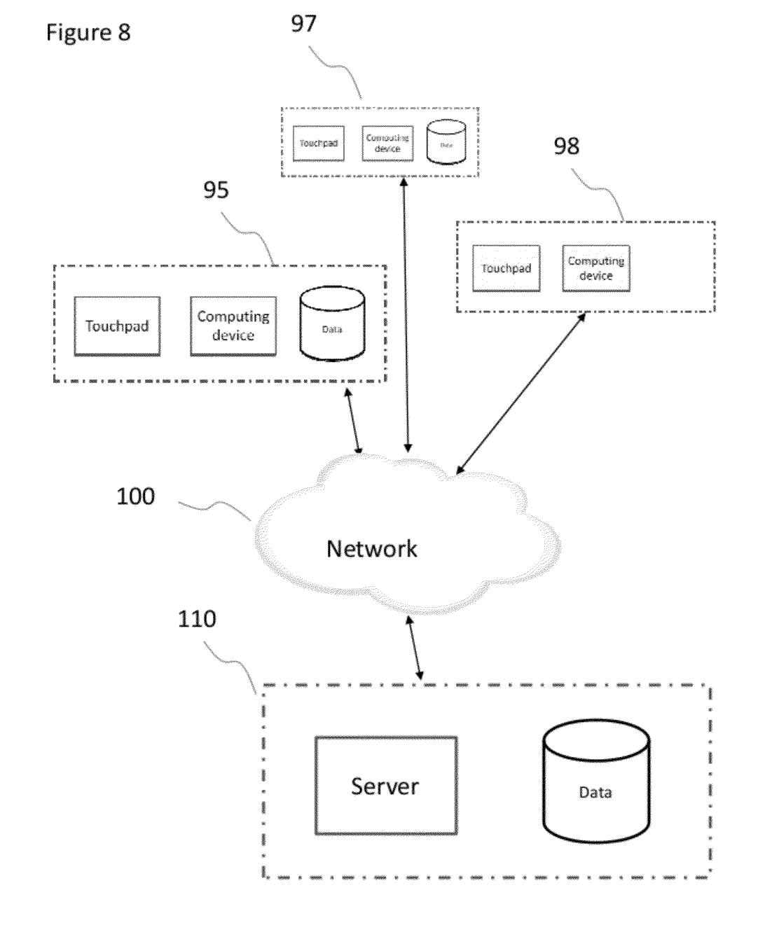

FIG. 8 illustrates the advantage the second embodiment whereby a CFSP can be accessed from anywhere allowing the user to utilize a third party touchpad device for DFR entry, shown in the figure as a multiplicity of touchpad devices (95, 97, 98) whereby that device can access and utilize that user's CFSP via a public network 100 and remote server 110 and provide accurate recognition of the DFR input from dumb terminals which do not utilize local storage 98 or devices not owned by or associated with the user. For example, a user might utilize DFR using his CFSP on a touchscreen computing device in a public library.

A basic description of the hardware required is included: A touchpad or touch screen (“touchpad” or “pad”) capable of reading a finger signature (FS) and capable of determining the direction of a swiped finger or combination of more than one finger swiped simultaneously. The words touchpad, touchscreen and pad are used throughout but all represent the same type of device as related to the invention. The touchpad provides raw input data to the Computer (below). Some conventional devices combine touchscreen device and computing device into one device typically called “tablets.” Whether the computing device and touchscreen/touchpad are combined is inconsequential to the invention and description of the invention herein.

A computer device containing hardware and software (“Computer”) connected to the pad such that the Computer can read the input from the pad and determine a CES. The computer contains a central processing unit capable of running the necessary software which performs functions necessary to executive comparative analysis necessary to identify the relevant finger and swipe motions created by the user. Comparative analysis involves extracting pertinent data from the raw input data and then matching that pertinent data against data in the database to perform a match. The pertinent data is compiled into the eph.

A database (typically considered hardware+software) connected to the computing device such that the computing device can retrieve stored FSP for comparative analysis (see #2 above). The FSP/CFSP can also be referred-to as “comparative data.”

The database can be local to the computer, i.e. on an attached stored device, or remote where it is accessed by the computer over a computer network, such as the internet. If the database is remote, then it can be accessed by any computer connected to the network and thus any touchpad connected to any computer connected to the network.

1. A system for inputting written language into a computing device with the movements of the fingers of a hand, the system comprising:
a touchpad device having the ability to recognize a human touch and the direction of the movement of a human touch;
storage which can store electronic data and is accessible by the computing device which contains a CES Set;
software on the computing device or accessible and usable by the computing device which can access storage of a CES Set in storage;
software on the computing device or accessible and usable by the computing device which can receive input from the touchpad, determine the finger of the hand, the orientation of the hand on the device and the direction of a swipe of a finger or other part of the hand relative to the orientation of the hand on the device;
software on the computing device or accessible and usable by the computing device which can compare the input from the touchpad to the CES Set to determine a match against a CES, thus determining the user's intended character or word;
